(19) United States
(12) Patent Application Publication
(10) Pub. No.: US 2016/0176160 A1
(43) Pub. Date: Jun. 23, 2016

(54) RELEASE SHEET AND RELEASE SHEET-INCLUDING SILICONE RESIN SHEET

(71) Applicant: NITTO DENKO CORPORATION, Ibaraki-shi, Osaka (JP)

(72) Inventors: Ryota MITA, Osaka (JP); Hiroyuki KATAYAMA, Osaka (JP); Hirokazu MATSUDA, Osaka (JP); Haruka ONA, Osaka (JP); Takanori ONO, Kagawa (JP); Tomomi NISHI, Kagawa (JP)

(73) Assignee: NITTO DENKO CORPORATION, Ibaraki-shi, Osaka (JP)

(21) Appl. No.: 14/910,313

(22) PCT Filed: Aug. 1, 2014
(86) PCT No.: PCT/JP2014/070321

§ 371 Date: Feb. 5, 2016

(30) Foreign Application Priority Data
Aug. 8, 2013 (JP) 2013-165169
Jun. 17, 2014 (JP) 2014-124086

(51) Int. Cl. B32B 7/12; B32B 27/06; B32B 7/06

(52) U.S. Cl. CPC B32B 7/12; B32B 7/06; B32B 27/06; B32B 2307/7265

(57) ABSTRACT

A release sheet includes a first moisture impermeable substrate layer and a water-containing layer laminated at one surface in a thickness direction of the first moisture impermeable substrate layer and containing water. The release sheet is used by covering a pressure-sensitive adhesive surface of a silicone resin sheet with the water-containing layer.

### TECHNICAL FIELD

The present invention relates to a release sheet and a release sheet-including silicone resin sheet, to be specific, to a release sheet used so as to cover a silicone resin sheet and a release sheet-including silicone resin sheet.

### BACKGROUND ART

It has been conventionally known that an optical semiconductor element such as LED and LD is encapsulated by a silicone resin sheet to constitute an optical semiconductor device.

Such a silicone resin sheet is excellent in adhesiveness or pressure-sensitive adhesive), so that the surface thereof forms an adhesive surface. To prevent the adhesive surface of the silicone resin sheet from adhering to dust in the air and furthermore, from being brought into contact with another member, for example, it is proposed that the adhesive surface is covered with a release sheet made of a polyester substrate (ref: for example, Patent Document 1).

### CITATION LIST

### Patent Document

Patent Document 1: Japanese Unexamined Patent Publication No. 2012-12563

### SUMMARY OF THE INVENTION

### Problem to be Solved by the Invention

When the release sheet described in the above-described Patent Document 1 is peeled from the adhesive surface of the silicone resin sheet, there may be a case where interfacial peeling fails to occur between the adhesive surface of the silicone resin sheet and the surface of the release sheet, and the silicone resin sheet causes cohesive failure. In such a case, there is a disadvantage that the thickness of the silicone resin sheet becomes non-uniform, so that the reliability thereof is reduced.

Even when interfacial peeling occurs between the adhesive surface of the silicone resin sheet and the surface of the release sheet, there is a disadvantage that the release sheet is not capable of being easily peeled from the silicone resin sheet because the peeling adhesive force thereof is high.

It is an object of the present invention to provide a release sheet that, when the release sheet is peeled from a silicone resin sheet, prevents cohesive failure of the silicone resin sheet to cause interfacial peeling between an adhesive surface of the silicone resin sheet and the surface of the release sheet and is capable of being easily peeled from the silicone resin sheet, thereby easily preventing a reduction in reliability of the silicone resin sheet, and a release sheet-including silicone resin sheet that includes the release sheet.

### Means for Solving the Problem

A release sheet of the present invention includes a first moisture impermeable substrate layer and a water-containing layer laminated at one surface in a thickness direction of the first moisture impermeable substrate layer and containing water, wherein the release sheet is used by covering a pressure-sensitive adhesive surface of a silicone resin sheet with the water-containing layer.

In the release sheet of the present invention, it is preferable that the water-containing layer further contains a water absorbent and the water content in the water-containing layer is 60 mass % or more and 95 mass % or less.

In the release sheet of the present invention, it is preferable that the water content in the water-containing layer after storing the release, sheet at a temperature of 5° C. and humidity of 30 to 70% RH for one week is 60 mass % or more and 95 mass % or less.

In the release sheet of the present invention, it is preferable that the water content in the water-containing layer after storing the release sheet at a temperature of 5° C. and humidity of 30 to 70% RH for one month is 60 mass % or more and 95 mass % or less.

In the release sheet of the present invention, it is preferable that the water-containing layer further contains a moisturizing agent.

In the release sheet of the present invention, it is preferable that the water absorbent contains gelatin and the water-containing layer further contains a transglutaminase.

In the release sheet of the present invention, it is preferable that the water-containing layer has a thickness of 30 μm or more and 1000 μm or less.

In the release sheet of the present invention, it is preferable that a second moisture impermeable substrate layer laminated at one surface in the thickness direction of the water-containing layer is further included.

A release sheet-including silicone resin sheet of the present invention includes the above-described release sheet and a silicone resin sheet having a pressure-sensitive adhesive surface in contact with the water-containing layer of the release sheet.

### Effect of the Invention

The release sheet of the present invention is, when the release sheet is peeled from the silicone resin sheet, capable of preventing cohesive failure of the silicone resin sheet to cause interfacial peeling between the pressure-sensitive adhesive surface of the silicone resin sheet and the surface of the release sheet, and is capable of being easily peeled from the silicone resin sheet. Thus, a reduction in reliability of the silicone resin sheet is capable of being prevented.

As a result, by covering the silicone resin sheet with the release sheet of the present invention, the release sheet-including silicone resin sheet of the present invention having excellent reliability can be provided.

### BRIEF DESCRIPTION OF THE DRAWINGS

FIG. 1 shows a sectional view of one embodiment of a release sheet of the present invention.

FIG. 2 shows usage of the release sheet in FIG. 1, illustrating a step of disposing a silicone resin sheet in the release sheet.

FIG. 3 shows usage of the release sheet in FIG. 1, illustrating a step of covering the release sheet with a second moisture impermeable substrate layer.

### DESCRIPTION OF EMBODIMENTS

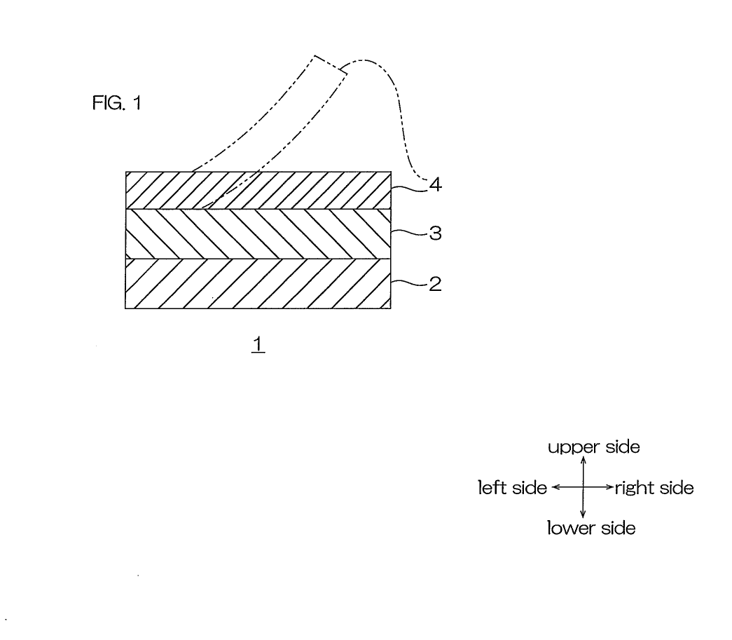

In FIG. 1, the upper side of the paper surface is referred to as an upper side (one side in a thickness direction, one side in a first direction); the lower side of the paper surface is referred to as a lower side (the other side in the thickness direction, the other side in the first direction); the left side of the paper surface is referred to as a left side (one side in a second direction orthogonal to the first direction); the right side of the paper surface is referred to as a right side (the other side in the second direction); the near side of the paper surface is referred to as a front side (one side in a third direction orthogonal to the first and second directions); and the far side of the paper surface is referred to as a rear side (the other side in the third direction). Directions in views other than FIG. 1 are in conformity with the directions in FIG. 1.

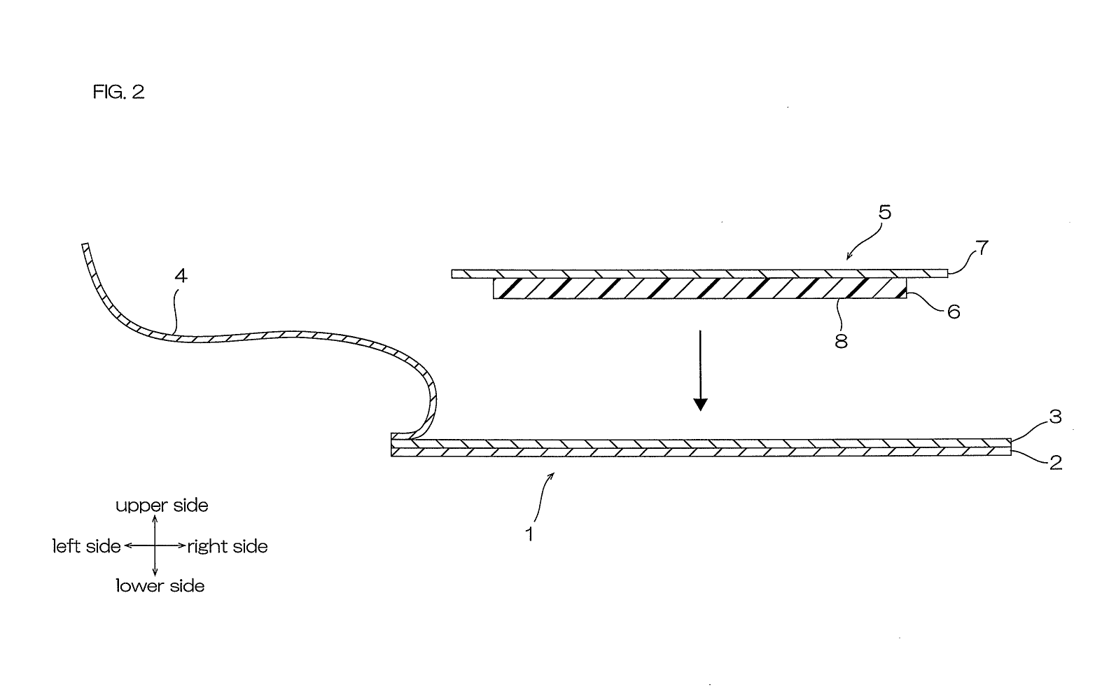

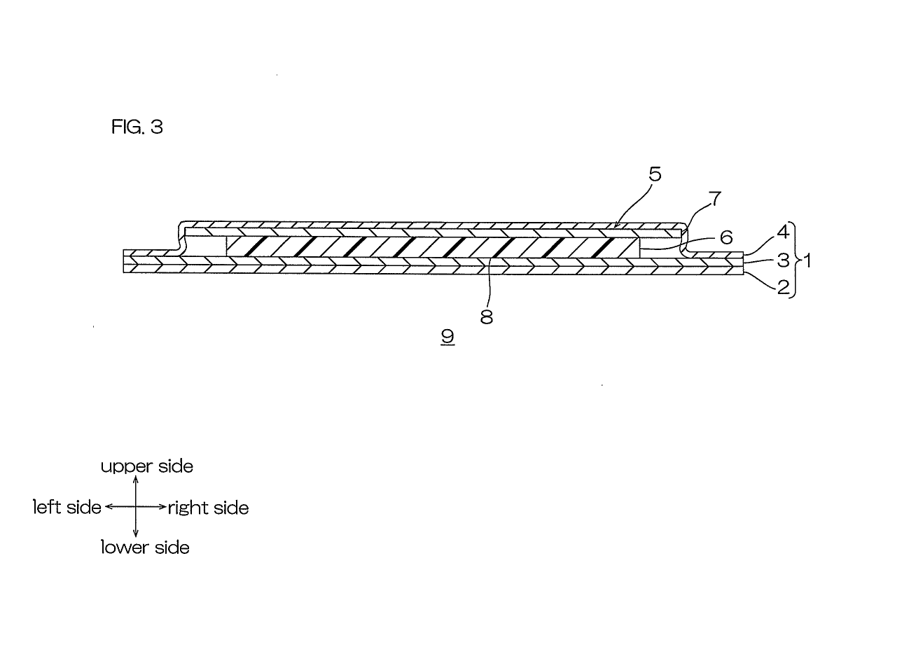

In FIG. 1, a release sheet 1 that is one embodiment of a release sheet of the present invention is attached to a pressure-sensitive adhesive surface 8 of a silicone resin sheet 6 (ref: FIG. 2) so as to be capable of being peeled (released) in order to protect the silicon resin sheet 6 until the silicone resin sheet 6 encapsulates an element such as an optical element and an electronic element to be described later (ref: FIG. 3). That is, as referred to FIG. 3, the release Sheet 1 is a flexible film that is laminated on the pressure-sensitive adhesive surface 8 of the silicone resin sheet 6 so as to cover the pressure-sensitive adhesive surface 8 of the silicone resin sheet 6 at the time of shipping, conveying, and storing a substrate layer-including silicone resin sheet 5 including the silicone resin sheet 6 and can be peeled from the pressure-sensitive adhesive surface 8 of the silicone resin sheet 6 so as to curve in a generally U-shape immediately before using the substrate layer-including silicone resin sheet 5. That is, the release sheet 1 does not include the substrate layer-including silicone resin sheet 5, the silicone resin sheet 6, and/or an element that is encapsulated by the silicone resin sheet 6. That is, the release sheet 1 is made of only the flexible film.

To be specific, the release sheet 1 includes a first moisture impermeable substrate layer 2, a water-containing layer 3 that is laminated on the upper surface (one surface in the thickness direction) of the first moisture impermeable substrate layer 2, and a second moisture impermeable substrate layer 4 that is laminated on the upper surface (one surface in the thickness direction) of the water-containing layer 3.

The first moisture impermeable substrate layer 2 is a base layer that supports the water-containing layer 3 and forms the outer shape of the release sheet 1. To be specific, the first moisture impermeable substrate layer 2 is formed into a sheet shape extending in a plane direction (direction orthogonal to the thickness direction, that is, a right-left, direction and a front-rear direction).

The first moisture impermeable substrate layer 2 is made of a moisture impermeable substrate that substantially fails to have moisture permeability. An example of the moisture impermeable substrate includes an organic polymer including polyester such as polyethylene terephthalate (PET) and polyethylene naphthalate, a polyolefin such as polyethylene and polypropylene (PP), and polyamide. Preferably, polyester is used, or more preferably, PET is used.

The moisture permeability amount of the first moisture impermeable substrate layer 2 at a thickness of 100 μm in a moisture permeability test in accordance with JIS Z0208-1976 is, for example, 50 g/m²·24 hours or less, preferably 20 g/m²·24 hours or less, or more preferably 10 g/m²·24 hours or less, and, for example, 0.1 g/m²·24 hours or more. When the moisture permeability amount of the first moisture impermeable substrate layer 2 is not more than the above-described upper limit, scattering of water contained in the water-containing layer 3 can be effectively prevented.

The ten-point average surface roughness Rz of the upper surface of the first moisture impermeable substrate layer 2 in accordance with JIS B0601-1994 is, for example, 0.05 μm or more, or preferably 0.1 μm or more, and, for example, 1000 μm or less, preferably 100 μm or less, or more preferably 5 μm or less. When the ten-point average surface roughness Rz of the first moisture impermeable substrate layer 2 is within the above-described range, the peeling pressure-sensitive adhesive force of the first moisture impermeable substrate layer 2 with the water-containing layer 3 can be improved by an anchor effect.

The first moisture impermeable substrate layer 2 has a thickness of, for example, 4 μm or more, or preferably 50 μm or more, and, for example, 5000 μm or less, preferably 2000 μm or less, or more preferably 500 μm or less. When the thickness of the first moisture impermeable substrate layer 2 is not more than the above-described upper limit, an increase in cost can be suppressed. When the thickness of the first moisture impermeable substrate layer 2 is not less than the above-described lower limit, excellent moisture impermeability can be ensured and excellent handling ability can be secured.

The water-containing layer 3 is laminated on the entire upper surface of the first moisture impermeable substrate layer 2.

The water-containing layer 3 is a layer that contains water, to be specific, contains a water absorbent and water.

The water absorbent is a gel forming agent that has water absorbency and can form gel by water absorption. An example of the water absorbent includes a water absorbing polymer such as gelatin, a polyacrylic acid or a salt thereof, an alkali metal salt of carboxymethyl cellulose, an alkali metal salt of alginic acid, and bacterial cellulose.

The gelatin is derived protein and a water absorbing polymer that is synthesized from collagen. The kind of collagen is not particularly limited and examples thereof include glue gelatin and Jellice.

The polyacrylic acid is a polymer that is synthesized from an acrylic acid.

An example of the salt of polyacrylic acid includes a monovalent metal salt of polyacrylic acid such as sodium polyacrylate and potassium polyacrylate.

Examples of the alkali metal salt of carboxymethyl cellulose include a sodium salt of carboxymethyl cellulose and a potassium salt of carboxy methyl cellulose.

Examples of the alkali metal salt of alginic acid include sodium alginate and potassium alginate.

These water absorbents can be used alone or in combination.

As the water absorbent, preferably, in view of water absorbency and water retention, gelatin is used.

The water absorbent has a weight average molecular weight of, for example, 15000 or more; or preferably 61000 or more, and, for example, 250000 or less, or preferably 100000 or less. The weight average molecular weight of the water absorbent is calibrated with standard polystyrene by GPC. The weight average molecular weight of another agent other than the water absorbent is also calculated in the same manner as that described above.

The mixing ratio of the water absorbent in the water-containing layer 3 is adjusted so that the mixing ratio of the water (that is, water content) in the water-containing layer 3 is, for example, 60 mass % or more, preferably 65 mass % or more, and, for example, 95 mass % or less, or preferably 90 mass % or less. When the water content in the water-containing layer 3 is not more than the above-described upper limit, the shape of the water-containing layer 3 can be surely ensured. Meanwhile, when the water content in the water-containing layer 3 is not less than the above-described lower limit, the water absorbent can be uniformly compatible with the water and moreover, the releasability of the silicone resin sheet 6 (described later, ref: FIGS. 2 and 3) with respect to the water-containing layer 3 can be improved.

To be specific, the mixing ratio of the water absorbent in the water-containing layer 3 is, for example, 5 mass % or more, or preferably 10 mass % or more, and, for example, 40 mass % or less, or preferably 35 mass % or less.

The water-containing layer 3 can further contain, if necessary, a moisturizing agent and/or a transglutaminase in addition to the above-described components.

The moisturizing agent is an agent that prevents evaporation of the water contained in the water-containing layer 3. Examples of the moisturizing agent include a polyol, ester of a polyol and a fatty acid, and urea or a derivative thereof.

An example of the polyol includes a polyol having the total carbon number of 7 or more including dihydric alcohol such as ethylene glycol, trihydric alcohol such as glycerin, and poly(di)ethylene glycol and poly(di)glycerin (or poly(di)glycerol). The polyol has a number average molecular weight of, for example, 200 or more, or preferably 300 or more, and, for example, 10000 or less.

Examples of the fatty acid include a stearic acid and a lauric acid.

These moisturizing agents can be used alone or in combination.

As the moisturizing agent, preferably, trihydric alcohol is used, or more preferably, glycerin is used.

The mixing ratio of the moisturizing agent with respect to the water-containing layer 3 is, for example, 10 mass % or more, or preferably 20 mass % or more, and, for example, less than 50 mass %, or preferably 40 mass % or less.

When the water absorbent is the gelatin, the transglutaminase is contained in the water-containing layer 3. The transglutaminase is an enzyme (protein cross-linking enzyme) that increases the cross-linking degree (or promotes cross-linking) of the gelatin in the water-containing layer 3. The transglutaminase is contained in the water-containing layer 3, so that the strength of the water-containing layer 3 can be increased.

The mixing ratio of the transglutaminase with respect to 100 parts by mass of the total amount of the water absorbent and the water is, for example, above 0.001 parts by mass, preferably 0.002 parts by mass or more, or more preferably above 0.002 parts by mass, and, for example, 0.02 parts by mass or less, preferably 0.01 parts by mass or less, or more preferably less than 0.01 parts by mass. When the mixing ratio of the transglutaminase is not more than the above-described lower limit, there may be a case where cross-linking of the gelatin by the transglutaminase cannot be sufficiently promoted and thus, the shape of the water-containing layer 3 cannot be retained, or when the second moisture impermeable substrate layer 4 is peeled from the water-containing layer 3, the water-containing layer 3 is partially transferred to the second moisture impermeable substrate layer 4. Meanwhile, when the mixing ratio of the transglutaminase is above the above-described upper limit, there may be a case where a cross-linking reaction is promoted at the time of film-forming (application) to be described later, so that film-forming becomes difficult.

A commercially available product can be used as the transglutaminase. An example thereof includes Activa TG-S (manufactured by AJINOMOTO CO., INC.). Activa TG-S contains 1 mass % of the transglutaminase and 99 mass % of a secondary component (to be specific, sodium polyphosphate, sodium pyrophosphate anhydride, sodium L-ascorbate, lactose, dextrin, and the like).

Furthermore, the water-containing layer 3 can also contain a known additive at an appropriate proportion in addition to the above-described components.

The water-containing layer 3 has a thickness of for example, 30 μm or more, or preferably 50 μm or more, and, for example, 1000 μm or less, or preferably 200 μm or less. When the thickness of the water-containing layer 3 is not more than the above-described upper limit, the handling ability of the release sheet 1 can be improved, the light weight of the water-containing layer 3 can be achieved, and furthermore, the production cost of the release sheet 1 can be reduced. Meanwhile, when the thickness of the water-containing layer 3 is not less than the above-described lower limit, the water content in the water-containing layer 3 can be increased and thus, an efficient amount of water can remain in the water-containing layer 3.

The peeling pressure-sensitive adhesive force of the water-containing layer 3 with respect to the first moisture impermeable substrate layer 2 is higher than that of the silicone resin sheet 6 with respect to the water-containing layer 3.

The second moisture impermeable substrate layer 4 is a cover layer that covers the upper surface of the water-containing layer 3 and along with the first moisture impermeable substrate layer 2, prevents scattering of the water contained in the water-containing layer 3.

The second moisture impermeable substrate layer 4 is laminated on the entire upper surface of the water-containing layer 3. The second moisture impermeable substrate layer 4 is made of a moisture impermeable substrate that substantially fails to have moisture permeability. An example of the moisture impermeable substrate includes the same moisture impermeable substrate illustrated in the first moisture impermeable substrate layer 2. Preferably, a polyolefin is used, or more preferably, PP is used.

The second moisture impermeable substrate layer 4 has a thickness of, for example, 50 μm or less, preferably 40 μm or less, or more preferably 30 μm or less, and, preferably 10 μm or more. When the thickness of the second moisture impermeable substrate layer 4 is not more than the above-described upper limit, the followability with respect to the water-containing layer 3 can be improved. When the thickness of the second moisture impermeable substrate layer 4 is not less than the above-described lower limit, the moisture impermeability of the second moisture impermeable substrate layer 4 can be surely secured.

The peeling pressure-sensitive adhesive force of the second moisture impermeable substrate layer 4 with respect to the water-containing layer 3 is adjusted lower than the above-described peeling pressure-sensitive adhesive force of the water-containing layer 3 with respect to the first moisture impermeable substrate layer 2.

The release sheet 1 has a thickness of, for example, 50 μm or more, or preferably 100 μm or more, and, for example, 2000 μm or less, or preferably 500 μm or less.

Next, a method for producing the release sheet 1 is described.

In this method, first, the first moisture impermeable substrate layer 2 is prepared.

In this method, next, the water-containing layer 3 is laminated on the upper surface of the first moisture impermeable substrate layer 2.

To be specific, first, the water-containing layer 3 is produced. To produce the water-containing layer 3, for example, a water absorbent and water, and if necessary, a moisturizing agent, a transglutaminase, and an additive are blended to prepare a mixture by allowing the water absorbent to absorb the water. The resulting mixture is laminated (film-formed) on the upper surface of the first moisture impermeable substrate layer 2, while being formed into a sheet shape (into a water absorbing sheet). When the transglutaminase is blended, a transglutaminase aqueous solution prepared by dissolving the transglutaminase in water is prepared in advance and next, the water absorbent, the water, and the transglutaminase aqueous solution and if necessary, the moisturizing agent and the additive are blended to prepare a mixture by allowing the water absorbent to absorb the transglutaminase aqueous solution. The resulting mixture is laminated (film-formed) on the upper surface of the first moisture impermeable substrate layer 2, while being formed into a sheet shape (into a water absorbing sheet). Or, the water absorbent (including the additive) that is formed into a sheet shape in advance is impregnated with a mixture liquid prepared from the water and if necessary, the moisturizing agent, the transglutaminase, and the additive and then, the water absorbent is allowed to absorb the water. The obtained water absorbing sheet is laminated on the upper surface of the first moisture impermeable substrate layer 2.

Thereafter, the second moisture impermeable substrate layer 4 is disposed on the upper surface of the water-containing layer 3.

In this manner, the release sheet 1 is produced.

When the water-containing layer 3 contains the gelatin, in view of stability of gel in the water-containing layer 3, the release sheet 1 is refrigerated and frozen to be stored at, for example, 10° C. or less, or preferably 5° C. or less, and, for example, −5° C. or more, or preferably 0° C. or more.

The water content W2 of the water-containing layer 3 after storing the release sheet 1 at a temperature of 5° C. and humidity of 30 to 70% RE (to be more specific, humidity of 40 to 60% RH) for one week is, for example, 60 mass % or more, or preferably 65 mass % or more, and, for example, 95 mass % or less, or preferably 90 mass % or less. The rate of change (percentage of the absolute value obtained by subtracting W1 from W2 with respect to W1, that is, |W2−W1|/W1×100) of the water content W2 of the water-containing layer 3 after storing the release sheet 1 at a temperature of 5° C. and humidity of 30 to 70% RH (to be more specific, humidity of 40 to 60% RH) for one week with respect to the water content W1 of the water-containing layer 3 before storage (immediately after production) is, for example, 0% or more, and, for example, 10% or less, or preferably 5% or less.

The water content W3 of the water-containing layer 3 after storing the release sheet 1 at a temperature of 5° C. and humidity of 30 to 70% RH (to be more specific, humidity of 40 to 60% RH) for one month is, for example, 60 mass % or more, or preferably 65 mass % or more, and, for example, 95 mass % or less, or preferably 90 mass % or less. The rate of change (percentage of the absolute value obtained by subtracting W1 from W3 with respect to W1, that is, |W3−W1|/W1×100) of the water content W3 of the water-containing layer 3 after storing the release sheet 1 at a temperature of 5° C. and humidity of 30 to 70% RH (to be more specific, humidity of 40 to 60% RH) for one month with respect to the water content W1 of the water-containing layer 3 before storage (immediately after production) is, for example, 0% or more, and; for example, 10% or less, or preferably 5% or less.

When the water content W2 of the water-containing layer 3 after storage for one week, the water content W3 of the water-containing layer 3 after storage for one month, and/or the above-described rate of change of the water content (|W2−W1|/W1×100 or |W3−W1|/W1×100) are not less than the above-described lower limit, the water content in the water-containing layer 3 after storage for the above-described period can be increased. Thus, a sufficient amount of water can remain in the water-containing layer 3 after storage.

The water content after storage for the above-described period is measured by a method described in Examples later.

Next, a method for using the release sheet 1 so as to cover the substrate layer-including silicone resin sheet 5 is described with reference to FIGS. 1 and 2.

First, as shown by phantom lines in FIG. 1, in this method, the second moisture impermeable substrate layer 4 is peeled from the water-containing layer 3 in the release sheet 1. To be specific, a right end portion of the second moisture impermeable substrate layer 4 and a midway portion in the ht-left direction thereof are peeled from a right end portion of the water-containing layer 3 and a midway portion in the right-left direction thereof so that a left end portion of the second moisture impermeable substrate layer 4 is left on the upper surface of the water-containing layer 3. To be more specific, in the second moisture impermeable substrate layer 4, a portion corresponding to the substrate layer-including silicone resin sheet 5 to be described next is peeled from the water-containing layer 3.

Separately, as shown in FIG. 2, the substrate layer-including silicone resin sheet 5 is prepared.

The substrate layer-including silicone resin sheet 5 includes the silicone resin sheet 6 and a substrate layer 7 that is laminated on the upper surface of the silicone resin sheet 6.

The silicone resin sheet 6 is formed from a silicone resin into a sheet shape in a generally rectangular shape in plane view. Examples of the silicone resin include a curable silicone resin and a thermoplastic silicone resin. Preferably, a curable silicone resin is used.

Examples of the curable silicone resin include a two-step curable silicone resin and a one-step curable silicone resin. Preferably, a two-step curable silicone resin is used.

The two-step curable silicone resin has a two-step reaction mechanism in which the silicone resin is brought into a B-stage state (semi-cured) in a first-step reaction and is brought into a C-stage state (finally cured) in a second-step reaction. Meanwhile, the one-step curable silicone resin has a one-step reaction mechanism in which the silicone resin is completely cured in a first-step reaction. The B-stage state is a state between an A-stage state in which the two-step curable silicone resin is in a liquid state and a C-stage state in which the two-step curable silicone resin is completely cured. The B-stage state is also a state in which curing and gelation are slightly progressed and the compressive elastic modulus is smaller than the elastic modulus in the C-stage state.

An example of the two-step curable silicone resin includes a thermosetting silicone resin composition described in Japanese Unexamined. Patent Publication No. 2010-265436.

Also, for example, particles of phosphors, fillers, or the like are contained in the silicone resin at an appropriate proportion, so that a silicone resin composition containing those can be prepared.

The above-described silicone resin has the same properties as oil regarding the compatibility with respect to water, to be specific, is not substantially compatible with the water, that is, has water-repellent properties (that is, shows hydrophobic properties).

The silicone resin has pressure-sensitive adhesive properties (pressure-sensitive adhesiveness). Thus, the surfaces (the upper and lower surfaces) of the silicone resin sheet 6 form the pressure-sensitive adhesive surface 8.

The substrate layer 7 is, in plane view, formed into a generally rectangular sheet shape in plane view having a size including the silicone resin sheet 6. Examples of the substrate layer 7 include a polymer sheet such as a polyethylene sheet and a PET sheet, a ceramic sheet, and a metal foil. Preferably, a polymer sheet is used. A surface of the release sheet 2 can be also subjected to release treatment such as fluorine treatment.

To prepare the substrate layer-including silicone resin sheet 5, first, the substrate layer 7 is prepared. Separately, the above-described components are blended, thereby preparing a varnish containing a silicone resin composition.

Thereafter, the varnish is applied to the surface of the substrate layer 7, thereby forming a coated film. When the silicone resin is the two-step curable silicone resin, the coated film is heated and/or subjected to active energy application. In this manner, the two-step curable silicone resin is brought into the B-stage state (semi-cured).

In this manner, the substrate layer-including silicone resin sheet 5 including the silicone resin sheet 6 and the substrate layer 7 is prepared.

Next, as shown by an arrow in FIG. 2, the substrate layer-including silicone resin sheet 5 is disposed in the release sheet 1 so that the pressure-sensitive adhesive surface 8 of the silicone resin sheet 6 is brought into contact with the upper surface of the water-containing layer 3.

Thereafter, as shown in FIG. 3, the substrate layer-including silicone resin sheet 5 is covered with the second moisture impermeable substrate layer 4 that is once peeled off. To be specific, the lower surface in a midway portion in the right-left direction of the second moisture impermeable substrate layer 4 is brought into contact with the upper surface of the substrate layer 7 and subsequently, the lower surface in the right end portion of the second moisture impermeable substrate layer 4 is brought into contact with the lower surface of the water-containing layer 3.

That is, the circumferential end portion (the front end portion, the rear end portion, the left end portion, and the right end portion) of the second moisture impermeable substrate layer 4 is in tight contact with the water-containing layer 3, and the central portion (the midway portion in the front-rear direction and the midway portion in the right-left direction) thereof is in contact with the substrate layer 7.

The substrate layer-including silicone resin sheet 5 is sandwiched between the water-containing layer 3 and the second moisture impermeable substrate layer 4 in the thickness direction and is interposed between the water-containing layer 3 and the second moisture impermeable substrate layer 4.

In this manner, a release sheet-including silicone resin sheet 9 including the release sheet 1 and the substrate layer-including silicone resin sheet 5 that is covered with the release sheet 1 is obtained.

The water-containing layer 3 and the second moisture impermeable substrate layer 4 are in tight contact with the circumferential end portion of the release sheet-including silicone resin sheet 9. Thus, in the release sheet-including silicone resin sheet 9, the substrate layer-including silicone resin sheet 5 is sealed by the water-containing layer 3 and the second moisture impermeable substrate layer 4. Therefore, scattering of the water in the water-containing layer 3 in the substrate layer-including silicone resin sheet 5 is prevented.

Thereafter, the release sheet-including silicone resin sheet 9 is, if necessary, conveyed and/or stored.

Thereafter, to use the substrate layer-including silicone resin sheet 5 of the release sheet-including silicone resin sheet 9, first, the second moisture impermeable substrate layer 4 is peeled from the circumferential end portion of the water-containing layer 3 and the substrate layer.

Next, the release sheet 1 is peeled from the substrate layer-including silicone resin sheet 5. To be specific, the water-containing layer 3 is peeled from the pressure-sensitive adhesive surface 8 of the silicone resin sheet 6.

In this manner, the substrate layer-including silicone resin sheet 5 is used for various applications, for example, for encapsulation of an optical element such as LED and LD, an electronic element, and the like. The silicone resin sheet 6 can be light-peeled (that is, can be easily peeled with small force) from the water-containing layer 3 and thus, the uniformity in thickness of the silicone resin sheet 6 is ensured. Therefore, the substrate layer-including silicone resin sheet 5 is preferably used for encapsulation of the optical element that requires high accuracy of the thickness of the silicone resin sheet 6.

The release sheet 1 is, when the release sheet 1 is peeled from the silicone resin sheet 6, capable of preventing cohesive failure of the silicone resin sheet 6 to cause interfacial peeling between the pressure-sensitive adhesive surface 8 of the silicone resin sheet 6 and the surface of the release sheet 1, and is capable of being easily peeled from the silicone resin sheet 6. To be more specific, the silicone resin that forms the silicone resin sheet 6 is in an oil state, so that the silicone resin sheet 6 and the water-containing layer 3 can repel to each other.

Thus; a reduction in reliability of the silicone resin sheet 6 is capable of being prevented.

When the water-containing layer 3 further contains the water absorbent and the water content in the water-containing layer 3 is 60 mass % or more and 95 mass % or less, the water absorbent can be uniformly compatible with the water and moreover, the releasability of the silicone resin sheet 6 with respect to the water-containing layer 3 can be improved, while the shape of the water-containing layer 3 can be surely ensured, that is, the film-forming properties of the water-containing layer 3 is improved.

When the water content W2 of the water-containing layer 3 after storing the release sheet 1 at a temperature of 5° C. and humidity of 30 to 70% RH for one week is 60 mass % or more and 95 mass % or less, the water absorbent can be uniformly compatible with the water, while the shape of the water-containing layer 3 can be surely ensured.

When the water content W3 of the water-containing layer 3 after storing the release sheet 1 at a temperature of 5° C. and humidity of 30 to 70% RH for one month is 60 mass % or more and 95 mass % or less, the water absorbent can be uniformly compatible with, the water, while the shape of the water-containing layer 3 can be surely ensured.

When the water-containing layer 3 further contains the moisturizing agent, evaporation of the water contained in the water-containing layer 3 can be prevented.

When the water absorbent contains the gelatin and the water-containing layer 3 further contains the transglutaminase, the transglutaminase improves the cross-linking degree of the gelatin in the water-containing layer 3 and thus, the strength of the water-containing layer 3 can be increased.

When the thickness of the water-containing layer 3 is 30 μm or more and 1000 μm or less, the light weight of the water-containing layer 3 can be achieved, and furthermore, the production cost of the release sheet 1 can be reduced. Meanwhile, the water content in the water-containing layer 3 can be increased and thus, an efficient amount of water can remain in the water-containing layer 3.

Furthermore, when the release sheet 1 further includes the second moisture impermeable substrate layer 4 that is laminated on the upper side of the water-containing layer 3, scattering of the water from the water-containing layer 3 can be prevented along with the first moisture impermeable substrate layer 2.

As a result, by covering the silicone resin sheet 6 with the release sheet 1, the release sheet-including silicone resin sheet 9 having excellent reliability can be provided.

To be specific, the substrate layer-including silicone resin sheet 5 that is formed into a long length shape is covered with the release sheet 1 and thereafter, the obtained sheets are laminated in a roll shape, or the substrate layer-including silicone resin sheet 5 that is formed into a sheet shape is covered with the release sheet 1 and the obtained sheets can be laminated in multiple steps. Thus, the substrate layer-including silicone resin sheet 5 that is covered with the release sheet 1 is conveyed in small space and the conveyance cost can be reduced.

### Modified Examples

In the embodiment in FIG. 2, the right end portion of the second moisture impermeable substrate layer 4 and the midway portion in the right-left direction thereof are peeled from the water-containing layer 3. Alternatively, for example, though not shown, the entire second moisture impermeable substrate layer 4 can be also peeled from the water-containing layer 3.

Thereafter, the substrate layer-including silicone resin sheet 5 is disposed on the upper surface of the water-containing layer 3 and thereafter, the peeled second moisture impermeable substrate layer 4 is brought into contact with the upper surface of the circumference end portion of the water-containing layer 3 so as to cover the substrate layer-including silicone resin sheet 5.

In the embodiment in FIG. 1, the second moisture impermeable substrate layer 4 is provided in the release sheet 1. Alternatively, for example, though not shown, the release sheet 1 can be also made of the first moisture impermeable substrate layer 2 and the water-containing layer 3 without including the second moisture impermeable substrate layer 4.

In this structure, in view of ensuring the water content in the water-containing layer 3 for a long period of time, the thickness of the water-containing layer 3 is set to be, for example, 1000 μm or more.

Although not shown in FIG. 3, the second moisture impermeable substrate layer 4 is not provided in the release sheet-including silicone resin sheet 9 and the substrate layer 7 is exposed.

According to the modified example, the second moisture impermeable substrate layer 4 is not provided, so that the layer structure and the steps can be simplified.

### EXAMPLES

Values in Examples shown below can be replaced with the values (that is, the upper limit value or the lower limit value) described in the above-described embodiments.

### Example 1

### Production of Release Sheet

A first moisture impermeable substrate layer (the moisture permeability amount in a moisture permeability test in accordance with JIS Z0208-1976: 7 g/m²·24 hours, the ten-point average surface roughness Rz in accordance with HS B0601-1994: 0.75 μm) made of PET having a thickness of 100 μm was prepared.

Next, a water-containing layer having a thickness of 200 μm and prepared in accordance with the formulation described in Table 1 was laminated on the upper surface of the first moisture impermeable substrate layer. The water-containing layer caused cohesive failure during measurement of the peeling pressure-sensitive adhesive force, so that the peeling pressure-sensitive adhesive force of the water-containing layer with respect to the first moisture impermeable substrate layer was not capable of being calculated.

Thereafter, a second moisture impermeable substrate layer (the moisture permeability amount in a moisture permeability test in accordance with JIS Z0208-1976: 5 g/m²·24 hours, the ten-point average surface roughness Rz in accordance with JIS B0601-1994: 0.5 μm) made of PP having a thickness of 25 μm was disposed on the upper surface of the water-containing layer. The peeling pressure-sensitive adhesive force of the second moisture impermeable substrate layer with respect to the water-containing layer was 0.01 N/20 mm.

In this manner, a release sheet in a rectangular shape in plane view having a size of 20 mm×140 mm and having a thickness of 325 μm was obtained (ref: FIG. 1).

[Production of Release Sheet-Including Silicone Resin Sheet]

A silicone resin composition described in Example 1 in Japanese Unexamined Patent Publication No. 2010-265436 was prepared. Next, 100 parts by mass of the silicone resin composition, 20 parts by mass of silicone rubber particles (average particle size of 7 μm), and 10 parts by mass of YAG particles (average particle size of 7 μm) that were a yellow phosphor were mixed with a stirrer. In this manner, a varnish was prepared.

Next, the obtained varnish was applied onto the surface of a substrate layer made of PET having a thickness of 50 μm to be subsequently heated with an oven at 135° C. for 15 minutes, so that a substrate layer-including silicone resin sheet including a silicone resin sheet having a thickness of 600 μm and the substrate layer laminated on the silicone resin sheet was produced.

The silicone resin sheet formed a pressure-sensitive adhesive surface. The substrate layer-including silicone resin sheet was in a rectangular shape in plane view having a size of 20 mm×140 mm and had a thickness of 650 μm.

Next, in the release sheet, a right end portion of the second moisture impermeable substrate layer and a midway portion in the right-left direction thereof were peeled, from a right end portion of the water-containing layer and a midway portion in the right-left direction thereof (ref: FIG. 2).

Subsequently, the substrate layer-including silicone resin sheet was disposed in the release sheet so that the pressure-sensitive adhesive surface of the silicone resin sheet was in contact with the upper surface of the water-containing layer (ref: the arrow in FIG. 2).

Thereafter, the substrate layer-including silicone resin sheet was covered with the right end portion of the second moisture impermeable substrate layer and the midway portion in the right-left direction thereof that were once peeled off (ref: FIG. 3). To be specific, the lower surface in the midway portion in the right-left direction of the second moisture impermeable substrate layer was brought into contact with the upper surface of the substrate layer and subsequently, the lower surface in the right end portion of the second moisture impermeable substrate layer was brought into contact with the lower surface of the water-containing layer.

In this manner, a release sheet-including silicone resin sheet was obtained.

[Peeling of Substrate Layer-Including Silicone Resin Sheet]

First, the second moisture impermeable substrate layer was peeled from the circumference end portion of the water-containing layer, and the substrate layer. Subsequently, the release sheet was peeled from the substrate layer-including silicone resin sheet. To be specific, the water-containing layer was peeled from the pressure-sensitive adhesive surface of the silicone resin sheet.

### Examples 2 to 5

Treatment was performed in the same manner as that in Example 1, except that the water-containing layers were prepared in accordance with the formulation described in Table 1.

### Comparative Example 1

Treatment was performed in the same manner as that in Example 1, except that the water-containing layer was not provided.

Evaluation 1

(Solubility of Gelatin to Water)

The solubility of gelatin to water at the time of preparation of the water-containing layers in Examples 1 to 5 was evaluated in accordance with the following criteria. The results are shown in Table 1.

Criteria

Excellent: Gelatin sufficiently absorbed water to be compatible with each other.

Good: Most of gelatin absorbed water, but a part of the gelatin (1 mass % or more and less than 5 mass %) was not compatible with the water.

Poor: Most of gelatin absorbed water, but a part of the gelatin (5 mass % or more and less than 10 mass %) was not compatible with the water.

(Film-Forming Properties of Water-Containing Layer)

The film-forming properties of the water-containing layers in Examples 1 to 5 were evaluated in accordance with the following criteria. The results are shown in Table 1.

Criteria

Excellent: The film-forming properties were excellent, and the film strength was high.

Good: The film-forming properties were excellent, but the film strength was low.

Poor: The film-forming properties were slightly inferior, and the film strength was low.

(Releasability of Silicone Resin Sheet to Water-Containing Layer)

The releasability at the time of peeling the water-containing layers from the pressure-sensitive adhesive surfaces of the silicone resin sheets of Examples 1 to 5 was evaluated in accordance with the following criteria. Meanwhile, in Comparative Example 1, the releasability at the time of peeling the first moisture impermeable substrate layer from the pressure-sensitive adhesive surface of the silicone resin sheet was evaluated in accordance with the following criteria. The results are shown in Table 1.

Criteria

Excellent: Interfacial peeling between the upper surface of the release sheet and the pressure-sensitive adhesive surface of the silicone resin sheet occurred, and the release sheet was capable of being easily peeled from the silicone resin sheet.

Good: Interfacial peeling between the upper surface of the release sheet and the pressure-sensitive adhesive surface of the silicone resin sheet occurred, and the release sheet was capable of being peeled from the silicone resin sheet with small force.

Poor: Interfacial peeling between the upper surface of the release sheet and the pressure-sensitive adhesive surface of the silicone resin sheet occurred, and the release sheet was capable of being peeled from the silicone resin sheet with slightly larger force.

Bad: The silicone resin sheet caused cohesive failure, the silicone resin adhered to the upper surface of the first moisture impermeable substrate layer, and roughness (surface roughness) was confirmed on the surface of the silicone resin sheet.

TABLE 1

| | | | Evaluation | | |
|---|---|---|---|---|---|
| | Formulation of | | | Film-Forming | Releasability of |
| | Water-Containing Layer | | Solubility | Properties of | Silicone Resin |
| | [mass %] | | of Gelatin | Water- | Sheet to Water- |
| | Water | Gelatin | to Water | Containing Layer | Containing Layer |
| Ex. 1 | 60 | 40 | Poor | Excellent | Poor |
| Ex. 2 | 65 | 35 | Good | Excellent | Poor |
| Ex. 3 | 70 | 30 | Good | Excellent | Good |
| Ex. 4 | 80 | 10 | Excellent | Good | Good |
| Ex. 5 | 95 | 5 | Excellent | Poor | Good |

| | | | | |
|---|---|---|---|---|
| Comp. Ex. 1 | — | — | — | Bad |

### Examples 6 to 9

Release sheets were produced in the same manner as that in Example 1, except that the water-containing layers were prepared in accordance with the formulation and the thickness described in Table 2.

In Example 8, glycerin as a moisturizing agent was added to a gelatin solution treated in the same manner as that in Example 1, so that a water-containing layer was prepared.

### Example 10

A release sheet was produced in the same manner as that in Example 1, except that the water-containing layer was produced as follows.

That is, 40 g of an aqueous solution prepared by dissolving 0.4 g of Activa TG-S (1 mass % of a transgiutaminase, 99 mass % of a secondary component) in 39.6 g of water, 40 g of water, and 20 g of gelatin were blended and mixed, thereby preparing a mixture.

Thereafter, the obtained mixture was formed into a sheet shape on the upper surface of the first moisture impermeable substrate layer to form a film, so that a water-containing layer having a thickness of 50 μm was formed.

### Examples 11 to 14

Release sheets were produced in the same manner as that in Example 10, except that the mixing proportion of Activa TG-S (transglutaminase) in the water-containing layers was changed in accordance with Table 2.

Evaluation 2

In Examples 6 to 14, as for (1) the release sheets of the release sheet-including silicone resin sheets immediately after production, (2) the release sheets of the release sheet-including silicone resin sheets after storage at a temperature of 5° C. and humidity of 50% RH for one week, and (3) the release sheets of the release sheet-including silicone resin sheets after storage at a temperature of 5° C. and humidity of 50% RH for one month, the following items were evaluated.

(Water Content)

The water content of each of the water-containing layers in the above-described (1) to (3) in Examples 6 to 14 was measured with an infrared moisture meter. The results are shown in Table 2.

(Peeling Pressure-Sensitive Adhesive Force)

As for each of the above-described (1) to (3) in Examples 6 to 14, the peeling pressure-sensitive adhesive force of the silicone resin sheet with respect to the water-containing layer was measured by the following method. The results are shown in Table 2.

That is, the peeling pressure-sensitive adhesive force was measured by a 180° peeling test of the substrate layer-including silicone resin sheet with respect to the release sheet. In the 180° peeling test, first, the substrate layer-including silicone resin sheet was cut into a piece having a width of 20 mm and thereafter, the resistance force at the time of peeling the cut substrate layer-including silicone resin sheet at a peeling rate of 300 mm/min in a direction of 180 degrees with respect to the release sheet was calculated.

(Strength of Water-Containing Layer)

The strength of the water-containing layers of the above-described (1) in Examples 6 to 14 was evaluated based on the handling ability after being allowed to stand under an environment of 30° C. for one minute.

To be specific, the water-containing layers in a state of being sandwiched between the first moisture impermeable substrate layers and the second moisture impermeable substrate layers were put into an oven at 30° C. for one minute and next, immediately after taking out those from the oven, the second moisture impermeable substrate layers were peeled from the water-containing layers. At this time, evaluation was performed in accordance with the fragility of the water-containing layers and a presence or absence of transfer of the water-containing layers to the second moisture impermeable substrate layers based on interfacial fracture of the second moisture impermeable substrate layers and the water-containing layers.

The results are shown in Table 2.

The evaluation criteria were as follows.

Criteria

Good: The water-containing layer was retained as a film under an environment of 30° C., and transfer to the second moisture impermeable substrate layer was not confirmed.

Poor: The water-containing layer was retained as a film under an environment of 30° C., and transfer to the second moisture impermeable substrate layer was partially confirmed.

(Film-Forming Properties of Mixture)

The film-forming properties of the mixtures in Examples 10 to 14 were evaluated in accordance with the following criteria. The results are shown in Table 2. The evaluation criteria were as follows.

Criteria

Good: The mixture was capable of being excellently applied to the first moisture impermeable substrate layer.

Poor: The mixture was capable of being applied to the first moisture impermeable substrate layer, but in the mixture, an application defective portion caused by promotion of the cross-linking reaction of the gelatin by the transgiutaminase was partially observed.

TABLE 2

| | | | | | | Evaluation | | | | | | | |
|---|---|---|---|---|---|---|---|---|---|---|---|---|---|
| | | | | | | | | | | | | Strength | |
| | | | | | | Water Content (mass %) | | | Peeling Pressure-Sensitive | | | After | |
| | | Formulation of Water- | | | | Immedi- | | | Adhesive Force (N/20 mm) | | | Being | |
| | Thickness | Containing Layer | | | Activa | ately | After | After | Immedi- | | | Allowed | |
| | of Water- | [mass %] | | | TG-S | after | Storage | Storage | ately | After | After | to Stand | Film- |
| | Containing | | | Mois- | (Enzyme | Produc- | for One | for One | after | Storage | Storage | at 30° C. | Forming |
| | Layer | | Gel- | turizing | Content | tion | Week | Month | Produc- | for One | for One | for One | Prop- |
| | (μm) | Water | atin | Agent | of 1%) | W 1 | W 2 | W 3 | tion | Week | Month | Minute | erties |
| Ex. 6 | 30 | 80 | 20 | — | — | 80 | 63 | 64 | 0.02 | 0.07 | 0.06 | Poor | — |
| Ex. 7 | 50 | 80 | 20 | — | — | 80 | 78 | 78 | 0.01 | 0.08 | 0.08 | Poor | — |
| Ex. 8 | 50 | 50 | 20 | 30 | — | 78 | 77 | 71 | 0.05 | 0.04 | 0.14 | Poor | — |
| Ex, 9 | 200 | 80 | 20 | — | — | 81 | 81 | 81 | 0.01 | 0.07 | 0.02 | Poor | — |
| Ex. 10 | 50 | 80 | 20 | — | 0.4 | 81 | 81 | 81 | 0.01 | 0.02 | 0.02 | Good | Good |
| Ex. 11 | 50 | 80 | 20 | — | 0.1 | 81 | 81 | 81 | 0.01 | 0.02 | 0,02 | Poor | Good |
| Ex. 12 | 50 | 80 | 20 | — | 0.2 | 81 | 81 | 81 | 0.01 | 0.02 | 0.02 | Poor | Good |
| Ex. 13 | 50 | 80 | 20 | — | 1.0 | 81 | 81 | 81 | 0.01 | 0.02 | 0.02 | Good | Poor |
| Ex. 14 | 50 | 80 | 20 | — | 2.0 | 81 | 81 | 81 | 0.01 | 0.02 | 0.02 | Good | Poor |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The substrate layer-including silicone resin sheet including the release sheet is used for various applications, for example, for encapsulation of an optical element such as LED and LD and an electronic element.

### DESCRIPTION OF REFERENCE NUMERALS

1 Release sheet
2 First moisture impermeable substrate layer
3 Water-containing layer
4 Second moisture impermeable substrate layer
6 Silicone resin sheet
8 Pressure-sensitive adhesive surface
9 Release-sheet including silicone resin sheet

1. A release sheet comprising:
a first moisture impermeable substrate layer and
a water-containing layer laminated at one surface in a thickness direction of the first moisture impermeable substrate layer and containing water, wherein
the release sheet is used by covering a pressure-sensitive adhesive surface of a silicone resin sheet with the water-containing layer.

2. The release sheet according to claim 1, wherein
the water-containing layer further contains a water absorbent and the water content in the water-containing layer is 60 mass % or more and 95 mass % or less.

3. The release sheet according to claim 2, wherein
the water content in the water-containing layer after storing the release sheet at a temperature of 5° C. and humidity of 30 to 70% RH for one week is 60 mass % or more and 95 mass % or less.

4. The release sheet according to claim 2, wherein
the water content in the water-containing layer after storing the release sheet at a temperature of 5° C. and humidity of 30 to 70% RH for one month is 60 mass % or more and 95 mass % or less.

5. The release sheet according to claim 1, wherein
the water-containing layer further contains a moisturizing agent.

6. The release sheet according to claim 2, wherein
the water absorbent contains gelatin and
the water-containing layer further contains a transglutaminase.

7. The release sheet according to claim 1, wherein
the water-containing layer has a thickness of 30 μm or more and 1000 μm or less.

8. The release sheet according to claim 1 further comprising:
a second moisture impermeable substrate layer laminated at one surface in the thickness direction of the water-containing layer.

9. A release sheet-including silicone resin sheet comprising:
a release sheet including
a first moisture impermeable substrate layer and
a water-containing layer laminated at one surface in a thickness direction of the first moisture impermeable substrate layer and containing water and
a silicone resin sheet having a pressure-sensitive adhesive surface in contact with the water-containing layer of the release sheet.
